(19) United States
(12) Patent Application Publication
(10) Pub. No.: US 2006/0266532 A1
(43) Pub. Date: Nov. 30, 2006

(54) Multi-drive converter unit for driving multiple fire suppression accessories

(75) Inventor: Peter Moskun, Quebec (CA)

Correspondence Address: Dean D. Small;Armstrong Teasdale LLP, Ste. 2600, One Metropolitan Square, St. Louis, MO, 63102, US

(73) Assignee: ANSUL CANADA LIMITED

(21) Appl. No.: 11/332,742

(22) Filed: Jan. 13, 2006

Related U.S. Application Data
(60) Provisional application No. 60/684,045, filed on May 24, 2005.

(51) Int. Cl. A62C 3/07

(52) U.S. Cl. 169/62

(57) ABSTRACT

A system for driving multiple fire suppression accessories comprises a multi-drive converter unit and a first fire suppression accessory. The multi-drive converter unit has an input configured to be coupled to an engine output drive shaft of an engine and has at least two accessory drive shafts. The at least two accessory drive shafts are driven by the input and are configured to be coupled to at least two accessories. The first fire suppression accessory is detachably coupled to a first of the at least two accessory drive shafts.

### CROSS REFERENCE TO RELATED APPLICATIONS

The application relates to and claims priority from provisional patent application Ser. No. 60/684,045, titled “DUAL OUTPUT DRIVE BOX”, filed May 24, 2005, the complete subject matter of which is expressly hereby incorporated herein in its entirety.

### BACKGROUND OF THE INVENTION

This invention relates generally to drive boxes and converter units used to drive fire suppression accessory units, and more particularly, to converter units used in applications where more than one accessory unit is operated at the same time.

Fire fighting or fire suppression accessories such as pumps that can produce high pressures are important in the forestry industry, as well as in other applications. For example, water is not always readily available in the forest where it is needed to fight a fire. At times, water may be pumped thousands of feet through varying terrains and elevations to get to the fire. The water also needs to be delivered with a desired flow rate capacity. Other accessories, such as generators or devices used to deliver chemicals, may also be needed at the same location or a different location to fight the same forest fire.

A higher pressure pump may be used to overcome pressure and friction losses. Pressure loss is caused, in part, by increases in elevation, also referred to as “static head”. Typically, for every one foot of elevation there is a loss of approximately 0.5 pounds per square inch (psi), and static head is the difference in elevation between the pump discharge outlet and the nozzle at the end of the hose. For example, if the pump being used produces 100 psi and an elevation difference of 100 feet exists between the pump and the nozzle end of the hose, only 50 psi is available at the nozzle. Friction loss is a loss of pressure due to friction between the water and the hose. The friction loss increases as the flow in the hose increases.

Each pump or accessory is driven by a separate engine, and one pump driven by one engine may be referred to as a pumping unit. Multiple pumping units are often needed to satisfy the requirements for high-pressure and/or high volume delivery, or to deliver water to more than one location.

For example, more than one high pressure pump capable of delivering adequate volumes of water to higher elevations may be needed. To increase the flow and/or pressure of water beyond the capability of a single pump, two pumping units are needed, such as by running two separate high-pressure and/or volume pumping units in parallel. At times, even higher pressure pumps are needed to overcome pressure losses to deliver water to much higher elevations and thus two pumping units may be operated in tandem by feeding the discharge outlet from the first pump into the suction inlet of the second pump. This configuration increases the pressure by adding the pressure of the first pump to the pressure of the second pump. In some cases, larger amounts of water may need to be delivered to one or more locations at lower elevations separately or at the same time as water is required at the higher elevation.

As each pump and/or accessory requires a dedicated engine, the overall weight of equipment increases dramatically with each pump and accessory that is needed. This requires additional time and manpower to get the equipment to the required location, posing a problem in many situations, especially where portable devices are carried to a desired location at a fire on a firefighter's back. It may also require an operator at each pump unit.

Therefore, a need exists for a converter unit capable of satisfying the varying requirements presented by a forest fire, while still being sensitive to the weight and transportation issues experienced by the firefighter. Certain embodiments of the present invention are intended to meet these needs and other objectives that will become apparent from the description and drawings set forth below.

### BRIEF DESCRIPTION OF THE INVENTION

A system for driving multiple fire suppression accessories comprises a multi-drive converter unit and a first fire suppression accessory. The multi-drive converter unit has an input configured to be coupled to an engine output drive shaft of an engine and has at least two accessory drive shafts. The at least two accessory drive shafts are driven by the input and are configured to be coupled to at least two accessories. The first fire suppression accessory is detachably coupled to a first of the at least two accessory drive shafts.

A system for driving multiple fire suppression accessories comprises a multi-drive converter unit, a transmission and a first fire suppression accessory. The multi-drive converter unit has an input configured to be coupled to an engine output drive shaft of an engine and has at least first and second accessory drive shafts. The first and second accessory drive shafts are driven by the input and are configured to be coupled to at least two accessories. The transmission is coupled to at least one of the engine output drive shaft and the first and second accessory drive shafts for increasing or decreasing a rotational speed of a drive shaft. The first fire suppression accessory is detachably coupled to the first accessory drive shaft.

A system for driving multiple fire suppression accessories comprises a multi-drive converter unit and a first fire suppression accessory. The multi-drive converter unit has an input configured to be coupled to an engine output drive shaft of an engine, and means for transferring energy from the engine output drive shaft to at least first and second accessory drive shafts. The first and second accessory drive shafts are configured to be coupled to at least two fire suppression accessories. The multi-drive converter unit further comprises means for at least one of increasing, decreasing, and stopping rotation of at least one of the engine output drive shaft and the first and second accessory drive shafts. The first fire suppression accessory is detachable coupled to the first accessory drive shaft.

### BRIEF DESCRIPTION OF THE DRAWINGS

FIG. 1 illustrates a multiple drive (multi-drive) converter unit in accordance with an embodiment of the present invention.

FIG. 2 illustrates a multi-drive converter unit having a transmission in accordance with an embodiment of the present invention.

FIG. 3 illustrates a power transfer configuration which transforms a single input drive shaft into two output drive shafts in accordance with an embodiment of the present invention.

FIG. 4 illustrates an alternative power transfer configuration which transforms a single input shaft into two output drive shafts in accordance with an embodiment of the present invention.

FIG. 5 illustrates a cover used to enclose the power transfer configuration of FIG. 4 in accordance with an embodiment of the present invention.

FIG. 6 illustrates a cut-away view of a power transfer configuration and interconnection with an engine and first and second fire suppression accessories in accordance with an embodiment of the present invention.

FIG. 7 illustrates a system utilizing the multi-drive converter unit to drive multiple accessories in accordance with an embodiment of the present invention.

FIG. 8 illustrates a system utilizing one or more speed converters interconnected with the multi-drive converter unit in accordance with an embodiment of the present invention.

FIG. 9 illustrates a system utilizing the multi-drive converter unit of FIG. 1 and power transfer configuration of FIG. 4 interconnected with one or more clutches in accordance with an embodiment of the present invention.

FIG. 10 illustrates a system utilizing the multi-drive converter unit with a supplemental accessory being driven by the engine output drive shaft in accordance with an embodiment of the present invention.

FIG. 11 illustrates a system utilizing the multi-drive converter unit to drive two high pressure pumps in accordance with an embodiment of the present invention.

FIG. 12 illustrates a system utilizing the multi-drive converter unit to drive two volume pumps in accordance with an embodiment of the present invention.

FIG. 13 illustrates a system utilizing the multi-drive converter unit to drive two high pressure pumps connected in tandem in accordance with an embodiment of the present invention.

FIG. 14 illustrates a system utilizing the multi-drive converter unit to drive two different kinds of pumps in accordance with an embodiment of the present invention.

FIG. 15 illustrates a system utilizing the multi-drive converter unit to drive two different accessories producing two different outputs in accordance with an embodiment of the present invention.

FIG. 16 illustrates a system utilizing the multi-drive converter unit to drive two different accessories having a combined output in accordance with an embodiment of the present invention.

The foregoing summary, as well as the following detailed description of certain embodiments of the present invention, will be better understood when read in conjunction with the appended drawings. The figures illustrate diagrams of the functional blocks of various embodiments. The functional blocks are not necessarily indicative of the division between hardware circuitry. It should be understood that the present invention is not limited to the arrangements and instrumentality shown in the attached drawings.

### DETAILED DESCRIPTION OF THE INVENTION

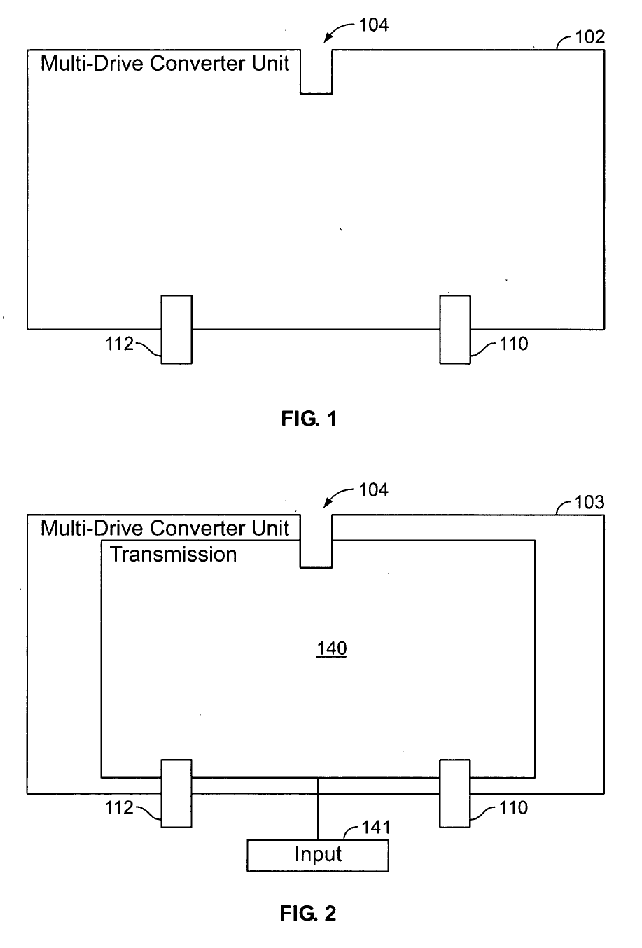

FIG. 1 illustrates a multiple drive (multi-drive) converter unit 102 in accordance with an embodiment of the present invention. The multi-drive converter unit 102 transfers the energy from a single rotating input shaft to multiple rotating output shafts to drive multiple fire suppression accessories and devices. A fire suppression accessory may be a pump for pumping water or other chemicals, including volume and high pressure pumps, electricity/electrical generators, air compressors, mist generators, foam generators and any other useful device that can be driven with a rotating shaft. Therefore, the multi-drive converter unit 102 provides a splitting capability, allowing multiple pumps and/or accessories to be driven by a single input, such as a single engine or transmission. The engine may be gas powered, such as diesel, electric, solar, or any other type of portable engine.

An input 104 accepts a rotating shaft from an engine, transmission, or other device (not shown). First and second accessory drive shafts 110 and 112 are coupled to and drive first and second accessories (not shown). It should be understood that more than two output drive shafts may be provided.

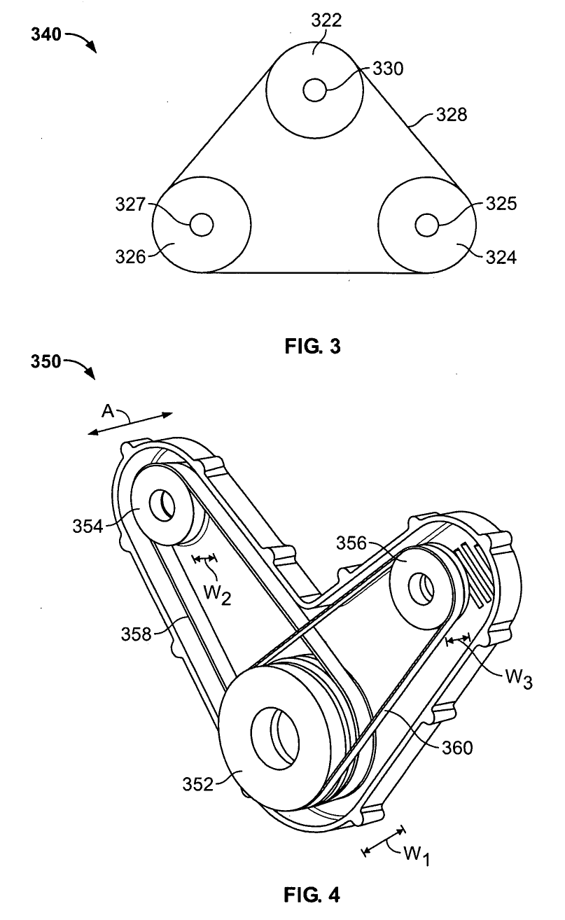

FIG. 2 illustrates a multi-drive converter unit 103 having a transmission 140 in accordance with an embodiment of the present invention. As with the multi-drive converter unit 102 of FIG. 1, a single engine drives multiple fire suppression accessories. A transmission 140 is interconnected with other parts and/or circuitry (not shown), and may be provided inside or outside of a cover, if provided, which encloses the multi-drive converter unit 103. The transmission 140 may use different configurations and components, for example, sprockets and a chain(s), pulleys and a belt(s), gears, a clutch, a hydraulic pump, and/or a motor. The input 104 accepts an external rotating drive shaft from an engine (not shown), and the transmission 140 may be used to speed up or slow down the revolutions per minute (RPM) of the engine output drive shaft, and/or increase or decrease the RPMs of the first and/or second accessory drive shafts 110 and 112 through input 141. The input 141 may be a button, dial, switch or other component and may be housed on a control panel. The multi-drive converter units 102 and 103 may also be used with a single shaft speed increaser (not shown) or an engine having an integral transmission.

FIG. 3 illustrates a power transfer configuration 340 which transforms a single input drive shaft into two output drive shafts in accordance with an embodiment of the present invention. The power transfer configuration 340 may be housed within the multi-drive converter unit 102 of FIG. 1. A driving pulley 322, a first pulley 324 and a second pulley 326 are arranged in a triangular relationship, but it should be understood that other geometric relationships may be used. The driving pulley 322 receives and is coupled to an engine output drive shaft (not shown) from an engine or transmission at an input 330. The first and second pulleys 324 and 326 are coupled to first and second accessory drive shafts 110 and 112 (FIG. 1) at holes 325 and 327. A belt 328 interconnects the driving pulley 322 and first and second pulleys 324 and 326. When the engine output drive shaft rotates, the driving pulley 322 rotates, moving the belt 328 and rotating the first and second pulleys 324 and 326, which drives the fire suppression accessories attached to the first and second accessory drive shafts 110 and 112. The movement of the belt 328 may be facilitated by friction, tension, teeth, grooves, and the like provided on or by interfacing surfaces of the belt 328 and pulleys 322, 324 and 326.

FIG. 4 illustrates an alternative power transfer configuration 350 which transforms a single input shaft into two output drive shafts in accordance with an embodiment of the present invention. The power transfer configuration 350 may be within the multi-drive converter unit 102 of FIG. 1. A driving pulley 352 and first and second pulleys 354 and 356 are coupled to an engine output drive shaft and first and second accessory drive shafts 110 and 112 (FIG. 1), respectively, as previously discussed. The driving pulley 352 and first and second pulleys 354 and 356 are arranged having a substantially triangular geometry with respect to each other, but other geometries may be used.

Belt 358 interconnects the driving pulley 352 and the first pulley 354, while belt 360 interconnects the driving pulley 352 and the second pulley 356. By using different sized pulleys for the first and second pulleys 354 and 356, and/or different lengths of belts 358 and 360, the rotational speed of the first and second accessory drive shafts 110 and 112 can be different from one another. Optionally, the driving pulley 352 may have a width W1 which is greater than widths W2 and W3 of the first and second pulleys 354 and 356, respectively, to accommodate the two belts 358 and 360 side-by-side. The driving pulley 352 and the first and second pulleys 354 and 356 may be spatially configured wherein the first and second pulleys 354 and 356 are offset with respect to each other in the direction of arrow A to prevent the belts 358 and 360 from interfering with one another. Note that pulley 352 could be one pulley that is a double row or it could be two pulleys installed next to each other; in other words, a first driving pulley for driving the first pulley 354 and a second driving pulley for driving the second pulley 356. Optionally, the pulleys 352, 354 and 356 may be aligned within the same plane, substantially within the same plane, or within different planes. Alternatively, one or more of the components of the power transfer configuration 350 may be replaced with gears, sprockets and/or chains allowing the rotational speed of the respective accessory drive shaft to be increased or decreased, such as by an externally accessible knob, dial, switch and the like (not shown).

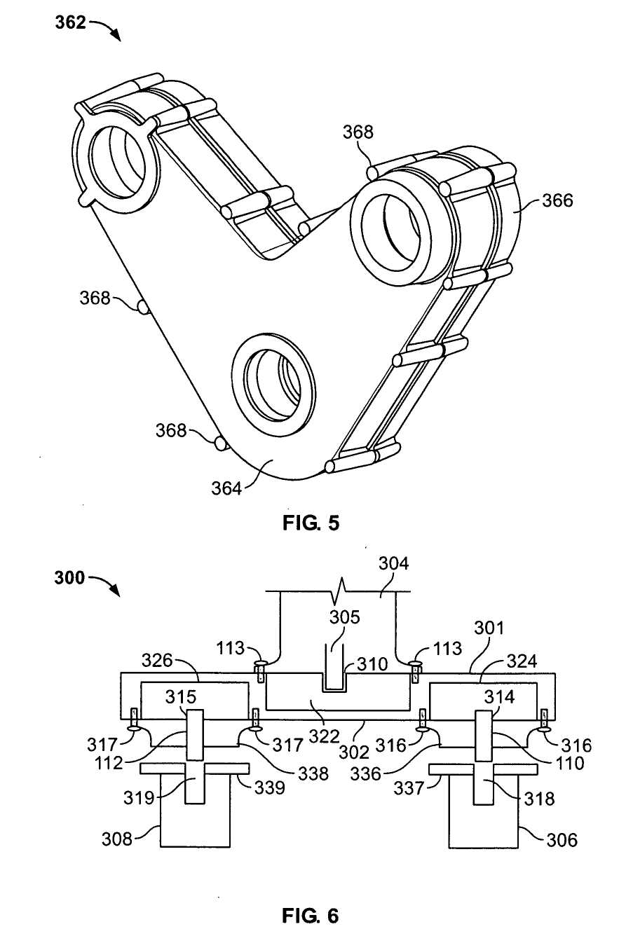

FIG. 5 illustrates a cover 362 used to enclose the power transfer configuration 350 of FIG. 4 in accordance with an embodiment of the present invention. The cover 362 may also enclose a transmission (if present), multiple gears, pulleys, belts and the like. The cover 362 may be formed of front and rear pieces 364 and 366 fastened together with bolts 368 or other suitable fasteners. The bolts 368 may be removable to allow servicing of the power transfer configuration 350.

FIG. 6 illustrates a cut-away view of a power transfer configuration and interconnection with an engine and first and second fire suppression accessories in accordance with an embodiment of the present invention. The driving pulley 322 and first and second pulleys 324 and 326 of the power transfer configuration 340 (FIG. 3) are illustrated, but it should be understood that other configurations may be used as well. However, the belt 328 is not illustrated. A housing or cover 300 encloses the power transfer configuration 340 and has top and bottom walls 301 and 302.

An engine 304 has an engine output drive shaft 305 which is inserted through an orifice 310 in the top wall 301. The input 330 (FIG. 3) of the pulley 322 accepts and is directly coupled to the engine output drive shaft 305. The input 330 and the engine output drive shaft 305 may be splined, have a key channel, be connected with a friction fit, and the like. The engine 304 may be attached to the top wall 301 with fasteners 113 which may be bolts, screws or other known fasteners.

First and second accessory drive shafts 110 and 112 extend from the first and second pulleys 324 and 326 outwardly through orifices 314 and 315, respectively, in the bottom wall 302. The first and second accessory drive shafts 110 and 112 may be splined, smooth, tension fit, friction fit, have a key channel, tightened via a set screw or locking screw, or any other interconnection known to those skilled in the art. First and second pump hubs 336 and 338 are securely fastened to the bottom wall 302, such as with one or more fasteners 316 and 317. The first and second accessory drive shafts 110 and 112 extend through and beyond the first and second pump hubs 336 and 338.

First and second accessory units 306 and 308 have inputs 318 and 319 for accepting and coupling to the first and second accessory drive shafts 110 and 112. In addition to the coupling describe above, the inputs 318 and 319 may provide a tapered fit to tighten down on the first and second accessory drive shafts 110 and 112. The first and second accessory units 306 and 308 are removable, or detachable, and may be coupled and un-coupled to the first and second pump hubs 336 and 338 with first and second coupling mechanisms 337 and 339. The first and second coupling mechanisms 337 and 339 may be the same or different from one another. For example, first and second coupling mechanisms 337 and 339 may be a pump or accessory clamp and may be coupled to and uncoupled from a pump hub by hand without the use of a tool. Alternatively, a ¼ turn clamping action may be used, actuated by putting the first coupling mechanism 337 of the first accessory unit 306 against the first pump hub 336 and turning it a ¼ turn to attach. Alternatively, the turning and clamping action could be anywhere from 1/1000 of a turn to 10 or more turns to attach the first accessory unit 306. The first coupling mechanism 337 may be snapped onto the first pump hub 336, attached by using a cam and/or cam lock, use of a threaded collar fastening onto the first pump hub 336, use of a ring which tightens as the ring is slid onto the first pump hub 336, or any other method or mechanism of coupling and un-coupling the first accessory unit 306 and the first pump hub 336 quickly and efficiently may be used. Optionally, an adapter (not shown) may be used to allow the interconnection between the first pump hub 336 and the first accessory unit 306.

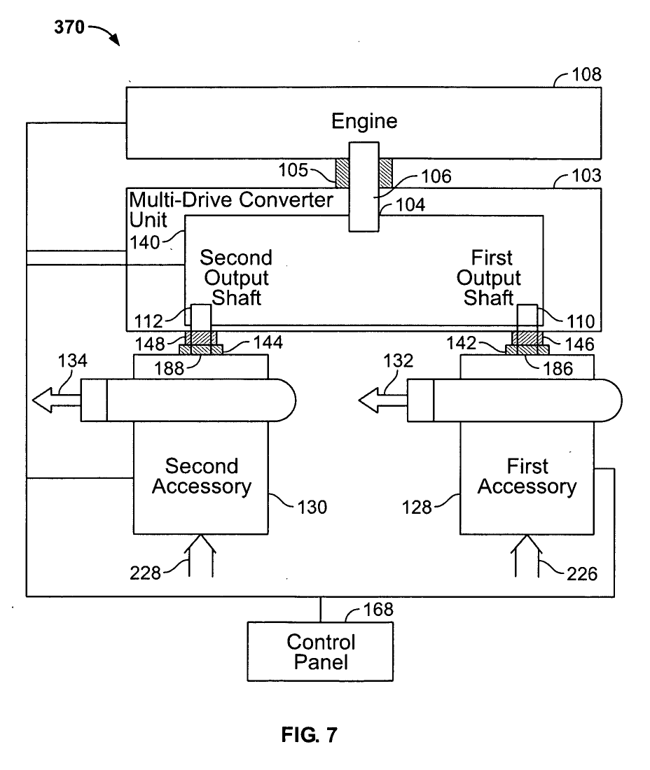

FIG. 7 illustrates a system 370 utilizing the multi-drive converter unit 103 to drive multiple accessories in accordance with an embodiment of the present invention. The input 104 of the multi-drive converter unit 103 receives an engine output drive shaft 106 from an engine 108. The engine 108 is securely fastened to the multi-drive converter unit 103, such as with a collar 105. Alternatively, the engine 108 and multi-drive converter unit 103 may be bolted together. The engine output drive shaft 106 drives the transmission 140, which in turn drives the first and second accessory drive shafts 110 and 112 with a power transfer configuration such as the power transfer configurations 340 and 350 of FIGS. 3 and 4, respectively. The first accessory drive shaft 110 is coupled to a first accessory input 186 to drive a first accessory 128, and the second accessory drive shaft 112 is coupled to a second accessory input 188 to drive a second accessory 130.

First and second pump hubs 146 and 148 are provided on the multi-drive converter unit 103. The first and second accessories 128 and 130 are removeably connected to the first and second pump hubs 146 and 148 with first and second coupling mechanisms 142 and 144, respectively, as discussed previously in FIG. 6, providing the ability to couple and un-couple the first and second accessories 128 and 130 individually, quickly and efficiently.

Each of the first and second accessories 128 and 130 has an input 226 and 228 and an output 132 and 134. The inputs 226 and 228 and outputs 132 and 134 depend upon the type of accessory, accepting and outputting, by way of example only, air, water, or a chemical composition, such as foam.

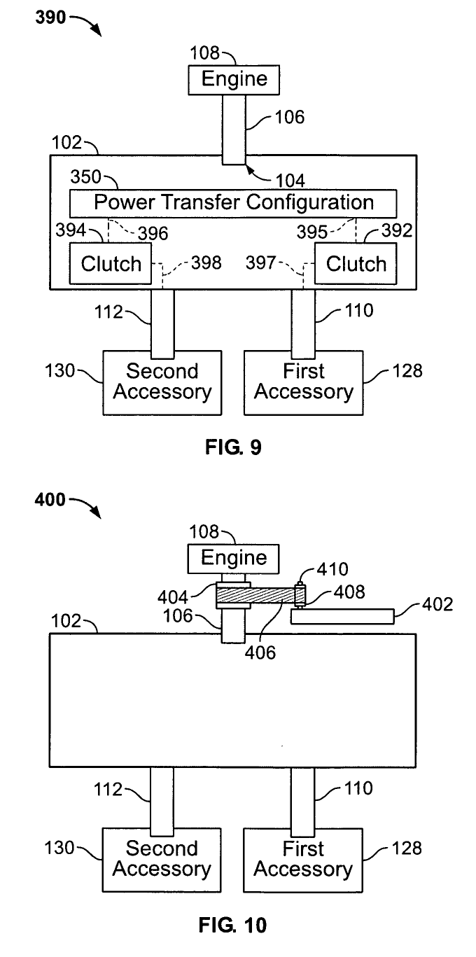

A control panel 168 may be interconnected to one, more than one, or all of the components of the system 370. The control panel 168 may offer functions such as buttons, dials and switches for speed control of the engine 108 and first and second accessories 128 and 130, for turning accessories on and off, and for controlling clutches, which are discussed below with FIG. 9. The control panel 168 may also have gauges and other displays to display pressures, RPMs and the like.

The engine 108, multi-drive converter unit 103 and the control panel 168 may be mounted to a carry frame (not shown), allowing the system 370 to be portable. The carry frame may be carried, for example, on the back of a fire-fighter to the location where the system 370 is needed.

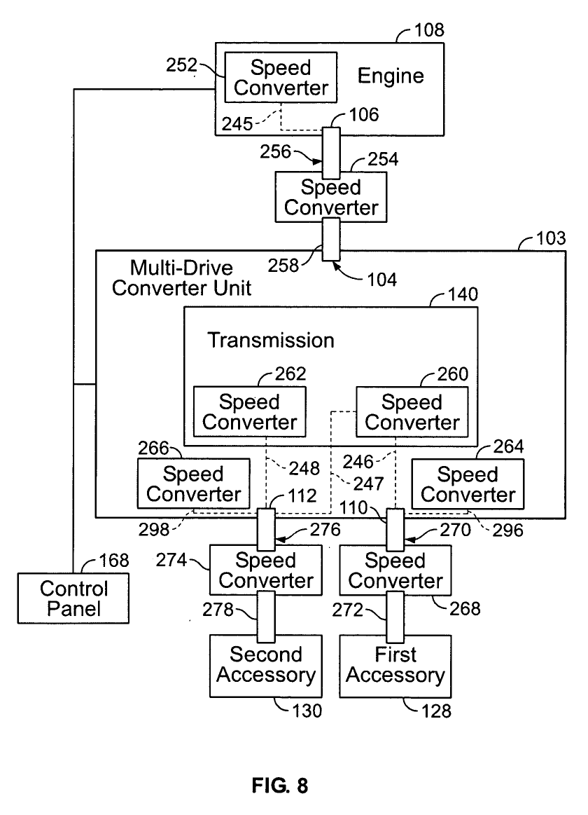

FIG. 8 illustrates a system 250 utilizing one or more speed converters interconnected with the multi-drive converter unit 103 in accordance with an embodiment of the present invention. The multi-drive converter unit 103 is configured to drive the first and second accessories 128 and 130, and the transmission 140 rotates the first and second accessory drive shafts 110 and 112 at one or more speeds or RPMs, based on the engine output drive shaft 106.

It should be understood that although multiple speed converters are illustrated, not all of the speed converters may be installed at one time. Speed converters may be added or removed from the system 250 depending upon the output delivery configuration needed. Speed conversion may be accomplished by adjusting the RPMs of the engine output drive shaft 106 by integrating a speed converter 252 with the engine 108. Thus, the output RPMs of the engine output drive shaft 106 may be increased or decreased at the engine 108 (connection illustrated by dotted line 245), such as by using a knob, dial, switch and the like, located on the engine 108, speed converter 252 or control panel 168. Alternatively, a speed converter 254 may have an input 256 which accepts the engine output drive shaft 106, and increases or decreases the RPMs of a speed converter output drive shaft 258 provided to the input 104 of the multi-drive converter unit 103.

Speed conversion may also be accomplished within the multi-drive converter unit 103 and/or the transmission 140. The transmission 140 may have one or more speed converters 260 and 262 within the mechanism of the transmission 140. For example, the speed converters 260 and 262 may be interconnected with the first and second accessory drive shafts 110 and 112, respectively, shown by dotted lines 246 and 248. Each of the speed converters 260 and 262 may be separately controlled by switches, knobs and the like, accessible on the control panel 168. Alternatively, the speed converter 260 may be interconnected with both the first and second accessory drive shafts 110 and 112 (dotted lines 246 and 247), adjusting the speed of the first and second accessory drive shafts 110 and 112 at the same time or substantially the same time. Optionally, one or more speed converters 264 and 266 may be within a housing or cover of the multi-drive converter unit 103, adjusting the speed of one or both of the first and second accessory drive shafts 110 and 112 individually or at the same time (dotted lines 296 and 298).

Speed conversion may also be accomplished between the multi-drive converter unit 103 and the first and second accessories 128 and 130. For example, a speed converter 268 may have a speed converter output drive shaft 272 and an input 270 accepting the first accessory drive shaft 110. A speed converter 274 may have a speed converter output drive shaft 278 and an input 276 accepting the second accessory drive shaft 112. The speed converters 268 and 274 may be separate units and control the speed of the first and second accessory drive shafts 110 and 112 separately. Alternatively, the speed converters 268 and 274 may be provided within a single unit or housing, and provide control of the speed of the first and second accessory drive shafts 110 and 112 separately and/or at the same time.

FIG. 9 illustrates a system 390 utilizing the multi-drive converter unit 102 of FIG. 1 and power transfer configuration 350 of FIG. 4 interconnected with one or more clutches in accordance with an embodiment of the present invention. Clutch 392 or 394 may be integrated with the power transfer configuration 350 (dotted lines 395 and 396) and/or the first and second accessory drive shafts 110 and 112 (dotted lines 397 and 398), allowing the first and second accessory drive shafts 110 and 112 to be stopped independently of each other. Therefore, one of the output drive shafts may be stopped to remove an installed accessory and/or replace an accessory to change the delivery configuration, such as by replacing a low volume pump with a high volume pump. The use of one or more clutches 392 and 394 allows the output configuration of the system 390 to be changed without stopping and starting the engine 108, and without interrupting the work being done by the other output drive shaft.

The clutches 392 or 394 may be mounted inside or outside the housing of the multi-drive converter unit 102. The configuration may be based on limitations and/or constraints such as size and weight. Additional clutches 392 and 394 can be attached outside as needed, allowing further flexibility in configuration. The clutches 392 and 394 may be electrical, mechanical, pneumatic, hydraulic, or any configuration known to those in the art.

FIG. 10 illustrates a system 400 utilizing the multi-drive converter unit 102 with a supplemental accessory 402 being driven by the engine output drive shaft 106 in accordance with an embodiment of the present invention. If needed, an extension (not shown) may be used to extend the length of the engine output drive shaft 106. By way of example only, first and second pulleys 404 and 408 may be connected to the engine output drive shaft 106 and an accessory input drive shaft 410, respectively. A belt 406 interconnects the first and second pulleys 404 and 408, turning the accessory input drive shaft 410 to drive the supplemental accessory 402 when the engine output drive shaft 106 turns. The speed of the accessory input drive shaft 410 may be set based on a relationship between first and second pulleys 404 and 408.

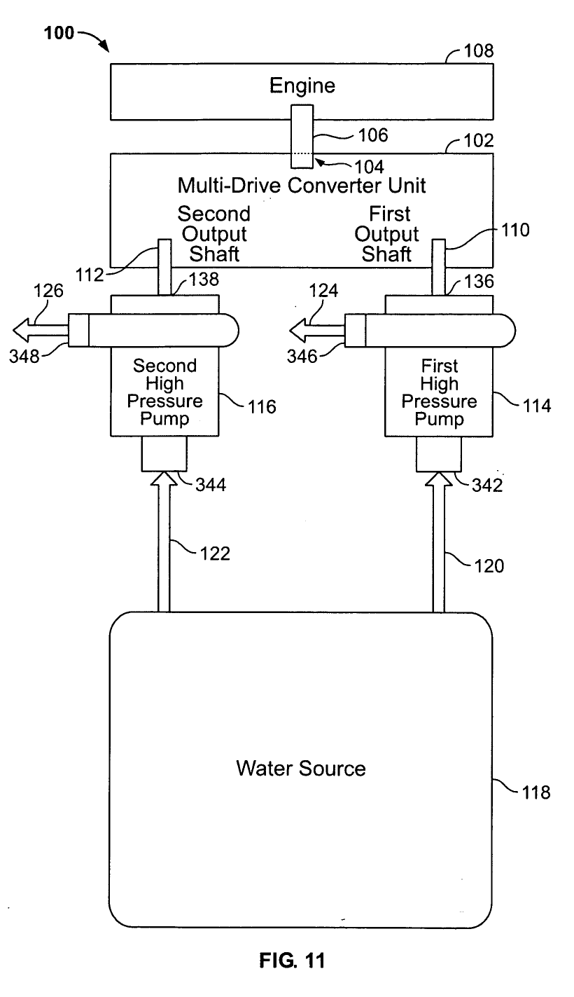

In FIGS. 11-16, multi-drive converter unit 102 is illustrated, but it should be understood that multi-drive converter unit 103 may also be used within the illustrated systems and configurations. In addition, a transmission, speed converters, control panels, and/or additional devices may be used to accomplish the desired output configuration.

FIG. 11 illustrates a system 100 utilizing the multi-drive converter unit 102 to drive two high pressure pumps in accordance with an embodiment of the present invention. The input 104 of the multi-drive converter unit 102 receives an engine output drive shaft 106 of an engine 108 or the output drive shaft of a transmission (not shown). The engine output drive shaft 106 drives the multi-drive converter unit 102 to turn the first and second accessory drive shafts 110 and 112. The first accessory drive shaft 110 is coupled to a first pump input 136 to drive a first high pressure pump 114, and the second accessory drive shaft 112 is coupled to a second pump input 138 to drive a second high pressure pump 116. The first and second high pressure pumps 114 and 116 draw water into suction inlets 342 and 344 from a water source 118, such as through hoses 120 and 122. The water is output through discharge outlets 346 and 348 to hoses 124 and 126. The first and second high pressure pumps 114 and 116 may be used to double the flow of water for higher elevation delivery.

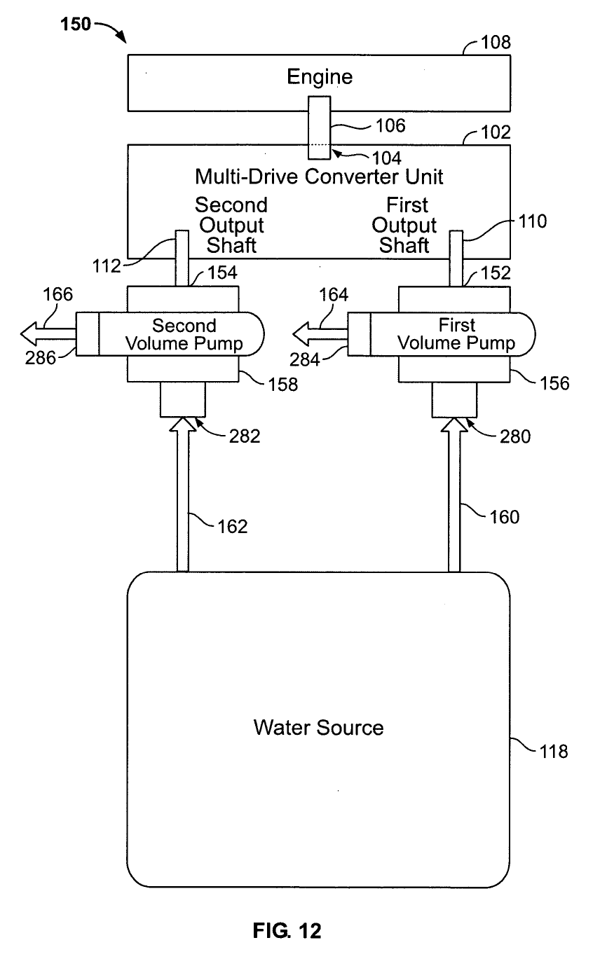

FIG. 12 illustrates a system 150 utilizing the multi-drive converter unit 102 to drive two volume pumps in accordance with an embodiment of the present invention. The first accessory drive shaft 110 is coupled to a first pump input 152 to drive first volume pump 156, and the second accessory drive shaft 112 is coupled to a second pump input 154 to drive second volume pump 158. The first and second volume pumps 156 and 158 draw water into suction inlets 280 and 282 from the water source 118 through hoses 160 and 162. The water is output through discharge outlets 284 and 286 to hoses 164 and 166. The first and second volume pumps 156 and 158 may be used to double the volume of water being delivered for lower elevations where there is minimal pressure loss.

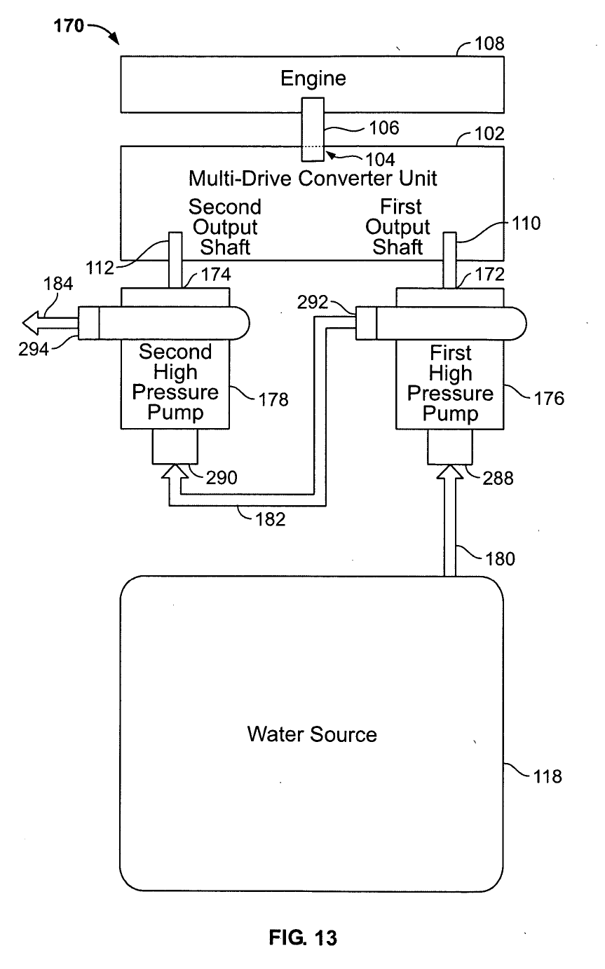

FIG. 13 illustrates a system 170 utilizing the multi-drive converter unit 102 to drive two high pressure pumps connected in tandem in accordance with an embodiment of the present invention. The first accessory drive shaft 110 is coupled to a first pump input 172 to drive a first high pressure pump 176, and the second accessory drive shaft 112 is coupled to a second pump input 174 to drive a second high pressure pump 178. The first high pressure pump 176 draws water into suction inlet 288 from the water source 118 through hose 180. The water is output through discharge outlet 292 to hose 182, which provides the input to suction inlet 290 of the second high pressure pump 178, which then outputs the water through discharge outlet 294 to hose 184. The pressures output from the first and second high pressure pumps 176 and 178 are added to one another, although the total pressure achievable may be limited and/or dependent upon the pressure rating of the hoses 182 and 184.

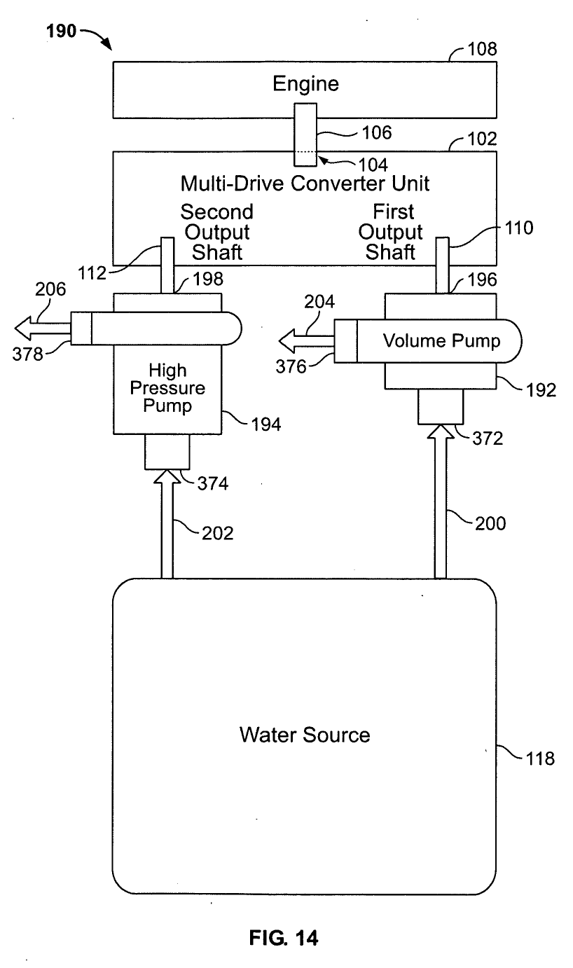

FIG. 14 illustrates a system 190 utilizing the multi-drive converter unit 102 to drive two different kinds of pumps in accordance with an embodiment of the present invention. The first accessory drive shaft 110 is coupled to a volume pump input 196 to drive volume pump 192, and the second accessory drive shaft 112 is coupled to a high pressure pump input 198 to drive high pressure pump 194. The volume and high pressure pumps 192 and 194 draw water into suction inlets 372 and 374 from the water source 118 through hoses 200 and 202, respectively. The volume pump 192 outputs the water through discharge outlet 376 to hose 204, such as to deliver water where there is minimal pressure loss (i.e. to fill a reservoir). The high pressure pump 194 outputs the water through discharge outlet 378 to hose 206, and may be used to fight a fire at higher elevations to overcome pressure loss.

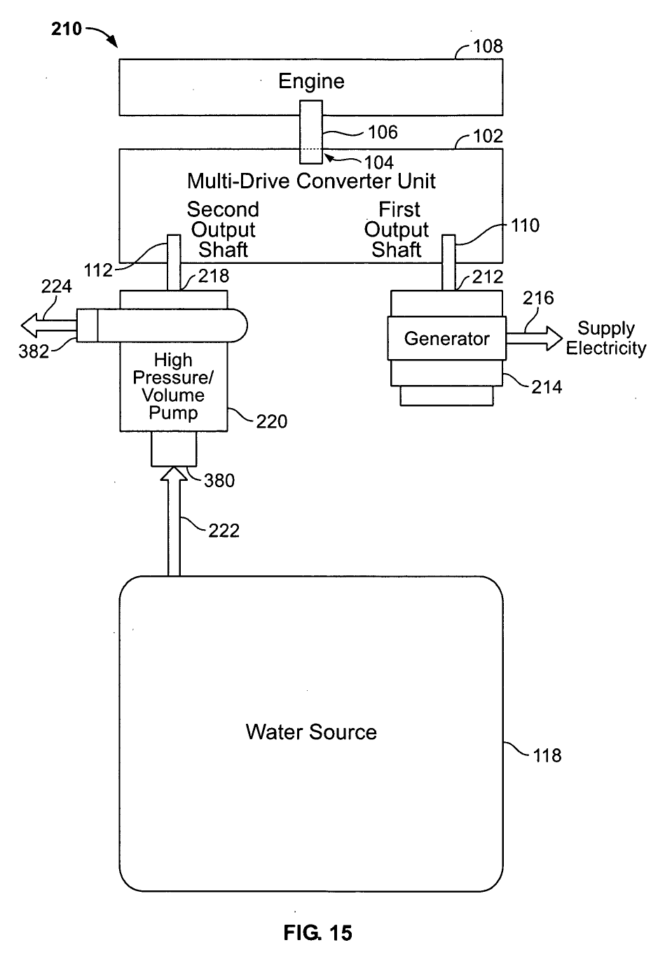

FIG. 15 illustrates a system 210 utilizing the multi-drive converter unit 102 to drive two different accessories producing two different outputs in accordance with an embodiment of the present invention. The first accessory drive shaft 110 is coupled to a generator input 212 to drive generator 214, which supplies electricity through line 216 to an additional device (not shown). The second accessory drive shaft 112 is coupled to a pump input 218 to drive pump 220, which may be a high pressure pump, a volume pump, or other type of pump. The pump 220 draws water into suction inlet 380 from the water source 118 through hose 222, and outputs the water through discharge outlet 382 to hose 224. It should be understood that many combinations and output configurations may be achieved by using different accessories.

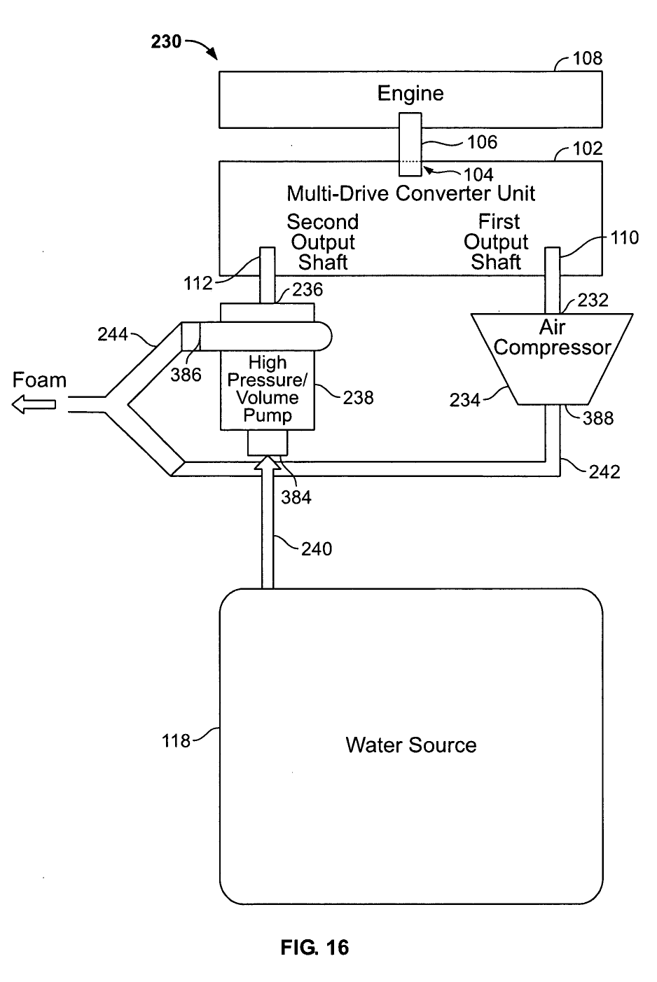

FIG. 16 illustrates a system 230 utilizing the multi-drive converter unit 102 to drive two different accessories having a combined output in accordance with an embodiment of the present invention. The first accessory drive shaft 110 is coupled to an air compressor input 232 to drive an air compressor 234, and the second accessory drive shaft 112 is coupled to a pump input 236 to drive a pump 238. The combination of the pump 238 and the air compressor 234 is also known as a compressed air foam system (CAFS). The pump 238 may be a high pressure pump, a volume pump, or other type of pump. The pump 238 draws water into suction inlet 384 from the water source 118 through hose 240. The air compressor 234 outputs air at a high pressure through discharge outlet 388 into hose 242, which is combined with water and/or an additional chemical agent output through discharge outlet 386 to hose 244 by the pump 238.

Therefore, the multi-drive converter units 102 and 103 may be combined with components such as clutches, speed converters and transmissions, and have different power transfer configurations. Many different output configurations can be created and easily changed to meet the needs of a forest fire or other situations which may benefit from the ability to operate multiple accessories while being sensitive to weight and transportation concerns.

While the invention has been described in terms of various specific embodiments, those skilled in the art will recognize that the invention can be practiced with modification within the spirit and scope of the claims.

What is claimed is:

1. A system for driving multiple fire suppression accessories, comprising:
a multi-drive converter unit having an input configured to be coupled to an engine output drive shaft of an engine, the multi-drive converter unit having at least two accessory drive shafts that are driven by the input, the at least two accessory drive shafts being configured to be coupled to at least two accessories; and
a first fire suppression accessory detachably coupled to a first of the at least two accessory drive shafts.

2. The system of claim 1, further comprising a second fire suppression accessory detachably coupled to a second of the at least two accessory drive shafts.

3. The system of claim 1, wherein the first fire suppression accessory is one of a volume pump, a high-pressure pump, an electricity generator, an air compressor and a mist generator.

4. The system of claim 1, wherein the multi-drive converter unit drives the at least two accessory drive shafts at different speeds.

5. The system of claim 1, further comprising a speed converter for converting a first rotational speed of the engine output drive shaft to a second rotational speed of at least one of the at least two accessory drive shafts.

6. The system of claim 1, further comprising a speed converter for converting a first rotational speed of the engine output drive shaft to a second rotational speed of at least one of the at least two accessory drive shafts, the speed converter being integrated into one of the engine and a transmission.

7. The system of claim 1, further comprising a speed converter for converting a first rotational speed of the engine output drive shaft to a second rotational speed, the speed converter further comprising an output shaft having the second rotational speed, the output shaft of the speed converter being used to drive the multi-drive converter unit.

8. The system of claim 1, wherein the first fire suppression accessory is coupled to the multi-drive converter unit by one of a clamp, ¼ turn clamping action, a snap fit, a cam, a cam lock, and a threaded collar.

9. The system of claim 1, further comprising a transmission wherein the rotational speed of at least one of the at least two accessory output shafts is capable of being varied with respect to the rotational speed of the engine output drive shaft.

10. The system of claim 1, further comprising a clutch interconnected with one of the at least two accessory drive shafts for interrupting the transfer of energy from the engine output drive shaft and the one of the at least two accessory drive shafts.

11. The system of claim 1, the multi-drive converter unit further comprising:
a first interconnecting mechanism interconnecting the engine output drive shaft and a first of the at least two accessory drive shafts; and
a second interconnecting mechanism interconnecting the engine output drive shaft and a second of the at least two accessory drive shafts, the first and second interconnecting mechanisms being separate from one another.

12. The system of claim 1, further comprising a supplemental fire suppression accessory directly coupled to the engine output drive shaft, the supplemental fire suppression accessory being operated at a rotational speed based on the rotational speed of the engine output drive shaft.

13. A system for driving multiple fire suppression accessories, comprising:
a multi-drive converter unit having an input configured to be coupled to an engine output drive shaft of an engine, the multi-drive converter unit having at least first and second accessory drive shafts that are driven by the input, the first and second accessory drive shafts being configured to be coupled to at least two accessories;
a transmission coupled to at least one of the engine output drive shaft and the first and second accessory drive shafts for increasing or decreasing a rotational speed of a drive shaft; and
a first fire suppression accessory detachably coupled to the first accessory drive shaft.

14. The system of claim 13, further comprising a supplemental fire suppression accessory directly coupled to the engine output drive shaft, the supplemental fire suppression accessory being operated at a rotational speed based on the rotational speed of the engine output drive shaft.

15. The system of claim 13, further comprising a clutch interconnected with one of the first and second output drive shafts, the clutch allowing one of the first and second output drive shafts to be stopped independently of the other.

16. The system of claim 13, further comprising:
a driving pulley coupled to the engine output drive shaft;
first and second pulleys coupled to first and second accessory drive shafts, respectively;
a first belt interconnecting the driving pulley and the first pulley; and
a second belt interconnecting the driving pulley and the second pulley.

17. The system of claim 13, further comprising a power transfer configuration for transferring energy from the engine output drive shaft to the first and second accessory drive shafts, the power transfer configuration comprising at least one of sprockets and a chain(s), pulleys and a belt(s), gears, a clutch, a hydraulic pump, and a motor.

18. The system of claim 13, further comprising:
the first fire suppression accessory further comprising a coupling mechanism; and
the multi-drive converter unit further comprising first and second pump hubs, the first and second accessory drive shafts extending beyond the first and second pump hubs, respectively, the first pump hub being coupled to the coupling mechanism.

19. The system of claim 13, further comprising an input for increasing or decreasing a rotational speed of at least one of the first and second output drive shafts.

20. A system for driving multiple fire suppression accessories, comprising:
a multi-drive converter unit having an input configured to be coupled to an engine output drive shaft of an engine, the multi-drive converter unit having means for transferring energy from the engine output drive shaft to at least first and second accessory drive shafts, the first and second accessory drive shafts being configured to be coupled to at least two fire suppression accessories, the multi-drive converter unit further comprising means for at least one of increasing, decreasing, and stopping rotation of at least one of the engine output drive shaft and the first and second accessory drive shafts; and
a first fire suppression accessory detachably coupled to the first accessory drive shaft.
